(19) United States
(12) Patent Application Publication
(10) Pub. No.: US 2026/0347560 A1
(43) Pub. Date: Nov. 5, 2026

(54) A Method Of Removing Ethylene Vinyl Alcohol Copolymer From A Waste Polymer Material

(71) Applicant: IONIQA TECHNOLOGIES B.V., Eindhoven (NL)

(72) Inventors: Jannigje Maria Jacomina GRAVENDEEL, Eindhoven (NL); Fabian WOUTERS, Eindhoven (NL)

(73) Assignee: Ioniqa Solutions B.V., Eindhoven (NL)

(21) Appl. No.: 19/491,046

(22) PCT Filed: Jun. 4, 2024
(86) PCT No.: PCT/NL2024/050282

§ 371 Date: Dec. 8, 2025

(30) Foreign Application Priority Data
Jun. 9, 2023 (NL) 2035061

(51) Int. Cl. C08J 11/08; B29B 17/02; B29K 23/00; B29K 67/00; C08J 11/24

(52) U.S. Cl. CPC C08J 11/08; B29B 17/02; C08J 11/24; B29B 2017/0203; B29B 2017/0244; B29K 2023/086; B29K 2067/003; C08J 2323/08; C08J 2367/02

(57) ABSTRACT

A method of removing ethylene vinyl alcohol copolymer from a waste polymer material that comprises polyester and ethylene vinyl alcohol copolymer is described. The method comprises providing the waste polymer material in shredded or cut form; contacting the waste polymer material in shredded or cut form with an alcoholic solvent at a temperature from 80 to 170 °C to dissolve the ethylene vinyl alcohol copolymer at least partly in the alcoholic solvent while the polyester remains substantially unaffected; separating the polyester from the solvent mixture comprising the alcoholic solvent and the vinyl alcohol copolymer dissolved therein by solid-liquid separation; precipitating the dissolved vinyl alcohol copolymer in the solvent mixture; separating the precipitated vinyl alcohol copolymer from the solvent mixture to vinyl alcohol copolymer and used alcoholic solvent. A method for depolymerizing the polyester from the waste polymer multilayer article is also described.

### FIELD OF THE INVENTION

The present invention is in the field of obtaining useful products from a waste polymer material. It particularly relates to a method of removing ethylene vinyl alcohol copolymer from a waste polymer multilayer article that comprises polyester, an ethylene vinyl alcohol copolymer and optionally a third polymer, such as a polyolefin. The invented method uses solvents and is environmentally friendly in that any solvents used in the method may be recycled. The invention also relates to a method for depolymerizing the polyester from the waste polymer multilayer article.

### BACKGROUND OF THE INVENTION

Polymer materials are widely used today in various articles, such as in carpets, apparel, covering, bedding, textiles, construction, packaging, and the like. Reuse and disposal of post-consumer polymer articles is complicated by the fact that these articles are increasingly composed of a number of distinct polymers that each contribute to a particular desired property. Multilayer packaging articles, such as packaging films used in food applications, for instance are quite common in the packaging industry nowadays and may exhibit many different polymer combinations based on specific product needs. Due to the presence of a variety of different polymers in multilayer packaging articles, their recyclability is problematic, and an industrially feasible solution has not been provided yet.

Polymer multilayer articles typically occur in three main categories, comprising flexible non-metallized articles, flexible metallized articles, and rigid non-metallized articles. The flexible articles are also referred to as multilayer films, whereas the rigid non-metallized articles are referred to as multilayer trays (MLT's) and typically derive their rigidity from the presence of a relatively thick polyester (such as PET) body.

In multilayer tray (MLT) applications, ethylene vinyl alcohol copolymer (such as EVOH) is typically combined with a polyolefin, such as polyethylene (PE) and/or polypropylene (PP), and a polycondensation polymer, such as polyester, for instance PET. A common type of MLT is a PE/EVOH/PET multilayer article, wherein each layer may have a different thickness.

Multilayer polymer articles are complex since they are constituted by distinct layers of heteropolymers such as polyolefins and polyesters, with each layer selected to contribute a specific property advantage to the article. For instance, polyethylene (PE) is often used for its flexibility and may act as a moisture barrier in packaging materials for medical and consumer goods. The ethylene vinyl alcohol copolymer (EVOH) may act as an oxygen barrier commonly used in food packaging materials, while polyethylene terephthalate (PET) may act as an effective gas and moisture barrier that imparts rigidity and strength. Adding to the complexity of these multilayer polymer articles are any number of tie layers (such as an ethylene vinyl acetate copolymer (EVA), adhesives and/or additives (such as TiO2) that may be present in small quantities compared to the main polymer fraction or factions.

The versatility and affordability of multilayer polymer articles have created a large demand for them. Accordingly, there is a large potential amount of waste multilayer articles available for capturing and reuse in their originally intended capacity.

It would be highly desirable to be able to provide a method of recycling waste polymer multilayer articles wherein at least a main polymer, such as the polyester in the multilayer article, is depolymerized into its building blocks for reuse as a circular raw material in repolymerization. It is known that the quality of the circular raw material resulting from depolymerization, i.e. the monomers, dimers and oligomers obtained by such a process, strongly depends on the removal of contaminants present in the waste polymer article. These contaminants typically include colorants and other additives such as fillers and plasticizers that may be present in the polymer material. In multilayer articles, polymers other than the depolymerized polyester are also viewed as contaminants since their presence in the depolymerization process and/or in the circular raw material obtained from such process may seriously affect the quality of the raw material. Obviously, this will also negatively affect the quality of the repolymerized product.

Therefore, the ability to selectively remove ethylene vinyl alcohol copolymer and optionally a third polymer, such as a polyolefin, from a waste polymer multilayer article is important. In other words, in order to be able to reuse the raw materials from which the waste polymer multilayer article is made requires an effective separation of the various polymers and a proper separation method is therefore needed.

It has been proposed in the art to deconstruct multilayer polymer films into their constituent polymers using a series of solvent washes that are guided by thermodynamic calculations of polymer solubility. This known method, referred to as solvent-targeted recovery and precipitation (STRAP), suffers from the fact that for each soluble polymer in a multilayer polymer article, a different solvent and process circumstances need to be used. For instance, Theodore W. Walker et al., ‘Recycling of multilayer plastic packaging materials by solvent-targeted recovery and precipitation’, Sci. Adv. 2020 (6), 2020 disclose a method for selectively dissolving the polyethylene (PE) and EVOH in a multilayer PET/EVOH/PE article by selectively dissolving the PE fraction in toluene at 110 °C and then separating the solubilized fraction from the EVOH and PET via mechanical filtration; and selectively dissolving the EVOH fraction in DMSO at 95 °C and then separating the solubilized fraction from the remaining PET.

WO2022157928A1 provides a method for extracting EVOH from a multilayer resin molded body containing an EVOH layer. The EVOH extraction agent comprises a polar solvent, such as DMSO, having a solubility parameter of 9 to 13 and a quaternary ammonium salt. The EVOH is recovered by precipitation with water and separation by filtration or centrifuge.

EVOH thus requires a polar solvent having a solubility parameter of 9 to 13, such as the aprotic polar solvent DMSO, while PE requires toluene. Each of the solvents may in some amounts remain in the polyester which seriously restricts the further use of such polyester. Also, because of the relatively high dissolving temperatures used, the dissolved polymer may not be separated efficiently from the solvent, which solvent therefore likely contains impurities. This hampers their reuse, which from an environmental point of view is undesirable.

There is a need therefore for an improved method of removing ethylene vinyl alcohol copolymer from a waste polymer multilayer article that comprises polyester, an ethylene vinyl alcohol copolymer and optionally a third polymer, such as a polyolefin, which method does not have the disadvantages of the prior art, or at least to a lesser extent.

Another object of the invention is to provide an improved separation method that is more cost effective and more robust, without generating further waste streams.

Yet another object is to provide an improved method of removing other polymers besides ethylene vinyl alcohol copolymer from a waste polymer multilayer article that comprises polyester and ethylene vinyl alcohol copolymer.

Yet another object is to provide a method that combines removing ethylene vinyl alcohol copolymer from a waste polymer multilayer article comprising polyester and ethylene vinyl alcohol copolymer and depolymerizing the polyester under conditions to obtain monomers and/or oligomers.

### SUMMARY OF THE INVENTION

In a first aspect, the present invention provides a method as claimed in claim 1. According to the claimed invention, a method of removing ethylene vinyl alcohol copolymer from a waste polymer material that comprises polyester and ethylene vinyl alcohol copolymer is provided that comprises the steps of:
a) providing the waste polymer material in size-reduced form;
b) contacting the waste polymer material in the size-reduced form with an alcoholic solvent at a temperature from 90 to 170 °C to dissolve the ethylene vinyl alcohol copolymer at least partly in the alcoholic solvent while the polyester remains substantially unaffected;
c) separating the polyester from the solvent mixture comprising the alcoholic solvent and the vinyl alcohol copolymer dissolved therein by solid-liquid separation;
d) precipitating the dissolved vinyl alcohol copolymer in the solvent mixture; and
e) separating the precipitated vinyl alcohol copolymer from the solvent mixture to obtain vinyl alcohol copolymer and used alcoholic solvent.

In a second aspect, the invention provides a method as claimed, further comprising adding a reactive solvent to disperse the polyester and obtain a dispersion; adding a depolymerization catalyst to the dispersion; and depolymerizing the polyester under conditions to obtain monomers and/or oligomers dissolved in the reactive solvent; wherein the reactive solvent comprises an alcoholic solvent, preferably at least a part of the used alcoholic solvent.

The inventors surprisingly found that the EVOH polymer layer forming part of a waste multilayer polymer article turned out to be separable from the multilayer polymer article by dissolving at a temperature from 90 to 170 °C in an alcoholic solvent typically also used as a reactive solvent in depolymerizing the polyester of the waste multilayer polymer article. It was further found that the EVOH polymer could be selectively separated from an optional third polymer such as a polyolefin, and that such optional third polymer could be separated from the solvent mixture by a density separation, thereby obviating the use of a separate solvent for the polyolefin.

The EVOH dissolved in the alcoholic solvent could be readily precipitated and separated from the alcoholic solvent mixture to obtain vinyl alcohol copolymer and used alcoholic solvent. In embodiments of the invention, the used alcoholic solvent could be reused in dissolving further EVOH and/or could be reused as a reactive solvent in depolymerizing the polyester.

### DETAILED DESCRIPTION OF THE INVENTION

In the context of the present disclosure, we first note that any range disclosed is supposed to include the end numbers of the range. Furthermore, as used herein, the terms ‘substantially’, ‘essentially’, ‘consisting essentially of, ‘essentially all’ and equivalents thereof have, as well as ‘about’ have, unless noted otherwise, in relation to a composition or a process step the usual meaning that deviations in the composition or process step may occur, but only to such an extent that the essential characteristics and effects of the composition or process step are not materially affected by such deviations. In addition, it is to be understood that the verb ‘to comprise’ and its conjugations are used in its non-limiting sense to mean that items following the word are included, but items not specifically mentioned are not excluded. Finally, reference to an element by the indefinite article ‘a’ or ‘an’ does not exclude the possibility that more than one of the element is present, unless the context clearly requires that there be one and only one of the elements. The indefinite article ‘a’ or ‘an’ thus usually means ‘at least one’.

### Multilayer Articles

According to the invention, the waste polymer material is typically supplied as a multilayer film or tray which is reduced in size. Size reduction may for instance be carried out by shredding, grinding, wet grinding, or cutting the waste polymer material to obtain flakes or pellets of appropriate size. Other methods of size-reduction may also be suitable. Shredding involves chopping the waste polymer material in a shredder. This may produce pieces of some length, such as strips or ribbons. Grinding or wet grinding generally provides smaller pieces. The waste polymer material may also be cut into smaller pieces with typical linear dimensions of 0.1 to 10 cm. In this form, the waste polymer multilayer material may comprise relatively small particles with typical linear dimensions of 0.1 to 10 cm, preferably from 0.5 to 6 cm, even more preferably from 0.8 to 4 cm. Suitable flakes for instance have the shape of a square with typical dimensions of 1×1 cm to 2×2 cm. In a preferred embodiment, the waste polymer material is substantially dry, and more preferably has a water content of less than 5 wt. %, even more preferably less than 3 wt. %, even more preferably less than 1 wt. %, based on the weight of the waste polymer material.

The waste polymer material comprises polyester and ethylene vinyl alcohol copolymer (EVOH), preferably in the form of distinct layers in a multilayer polymer article. In an optional embodiment, the waste polymer material may also comprise a polyolefin, preferably polyethylene (PE) in the form of a distinct layer.

EVOH copolymers that are suitable for use herein may contain at least about 50 mol %, and as much as 80 mol % of vinyl alcohol in the molecule. The preferred copolymers may contain about 60 to 75 mol % of the vinyl alcohol moiety. The remainder of the EVOH molecule consist essentially of ethylene between 20 and 50 mol. %, and preferably between 40 and 25 mol %. Because EVOH is typically produced by hydrolysis of ethylene vinyl acetate copolymers, some residual vinyl acetate may be present. Typically, there may be less than about 3 wt. % of vinyl acetate in the EVOH molecule, and preferably it may be present at a level below 1.5 wt. %. Typically, EVOH copolymers have densities of about 1.1 to 1.2 g/dm³, and their melting points typically range from about 160 °C to 190 °C. EVOH may degrade at temperatures above 230 °C.

The waste polymer material further comprises a polyester. In this class of condensation polymers, polyethylene terephthalate (PET) is the preferred polyester. PET may include further comonomers, such as isophthalic acid, diethylene glycol (DEG), and cyclohexane dimethanol (CHDM) to improve its properties, as known in the art. Other polyesters are however not excluded, such as polyethylene naphthalate (PEN), based on 2,6-naphthalenedicarboxylic acid and ethylene glycol. Other examples include so-called biodegradable polymers, such as polylactic acid (PLA), polybutylene terephthalate (PBT), polypropylene terephthalate, poly pentaerythrityl terephthalate and copolymers thereof, such as copolymers of ethylene terephthalate and polyglycols, for instance polyoxyethylene glycol and poly(tetramethylene glycol) copolymers, and further polycyclohexylenedimethylene-2,5-furandicarboxylate (PCF), polybutylene adipate-co-terephthalate (PBAT), polybutylene sebacate-co-terephthalate (PBSeT), polybutylene succinate-co terephthalate (PBST), polybutylene 2,5 furandicarboxylate-co-succinate (PBSF), polybutylene 2,5-furandicarboxylate-co-adipate (PBAF), polybutylene 2,5-furandicarboxylate-co-azelate (PBAzF), polybutylene 2,5 furandicarboxylate-co-sebacate (PBSeF), polybutylene 2,5-furandicarboxylate-co-brassy late (PBBrF), polybutylene 2,5-furandicarboxylate (PBF), polybutylene succinate (PBS), polybutylene adipate (PBA), polybutylne succinate-co-adipate (PBSA), polybutylene succinate-co-sebacate (PBSSe), polybutylene sebacate (PBSe), and copolymers thereof, for instance copolymers with polylactic acid and/or PET.

The waste polymer material may optionally comprise a distinct third polymer in addition to the polyester and EVOH, such as one or more of a polyolefin, polyvinylchloride, polyamide and/or polystyrene. The polyolefin may comprise polyethylene, polypropylene, or combinations thereof. In case the third polymer is a polyolefin, it may melt at the temperatures applied in step (b) of the method. In case the third polymer is a polyvinylchloride and/or a polystyrene, some grades thereof may neither melt nor dissolve in the alcoholic solvent in step (b) of the invented method.

The waste polymer multilayer material has the advantage that it typically does not comprise inorganic solids such as pieces of stone, glass, and metals, such as aluminum, steel, copper, brass, and nickel. Such materials may be present in other waste feedstock but rarely in waste polymer multilayer articles. The invention, however, may also handle inorganic solids and metals, if required.

### Removing EVOH

According to step b) of the invented method, the waste polymer material in size-reduced form is contacted with an alcoholic solvent at a temperature from 90 to 170 °C to dissolve the ethylene vinyl alcohol copolymer at least partly in the alcoholic solvent while the polyester remains substantially unaffected. Contacting may for instance be achieved by adding the alcoholic solvent to the waste polymer material or vice-versa.

The alcoholic solvent may be selected from mono-alcohols, di-alcohols, and tri-alcohols. Preferably, use is made of non-halogenated alcohols. More preferably, use is made of a polyol. It is preferred to use smaller chain alcohols, such as C6-C10 mono-alcohols, and likewise preferably C2-C10 di-alcohols, more preferably C2-C8 di-alcohols. Examples thereof are vicinal diols, and germinal diols. Examples of suitable alcohols include 1-hexanol, 3-methyl-1-pentanol, 4-methyl-1-pentanol, 1-heptanol, 2-heptanol, 3-heptanol, 4-heptanol, 1-octanol, 2-octanol, 2-ethyl-1-hexanol, 4-methyl-3-heptanol, 5-methyl-3-heptanol, 2,2,3-trimethyl-3-pentanol, 1-nonanol, 2-nonanol, 3-nonanol, 4-nonanol, 5-nonanol, 7-methyl-1-octanol, 2,6-dimethyl-4-heptanol, 3,5-dimethyl-4-heptanol, 3,5,5-trimethyl-1-hexanol, 1-decanol, and 1,4-benzenedimethanol, ethylene glycol (1,2-ethanediol) and diethylene glycol, 1,3-propanediol, 1,4-butanediol, 1,5-pentanediol, 1,2-pentanediol, hexane-1,2-diol, hexane-1,6-diol, heptane-1,2-diol, heptane-1,7-diol, octane-1,2-diol, octane-1,8-diol, nonane-1,3-diol, nonane-1,9-diol, decane-1,2-diol, decane-1,10-diol, undecane-1,2-diol, undecane-1,11-diol, dodecane-1,2-diol, and dodecane-1,12-diol. Preferred alcohols to be used in the second step in the appropriate embodiments comprise a glycol, more preferably an alkylene glycol, selected from ethylene glycol (1,2-ethane diol), propylene glycol (1,3-propane diol), 1,4-butane diol and 1,5-pentane diol.

The prior art requires using a polar solvent having a solubility parameter of 9 to 13 and a quaternary ammonium salt in order to dissolve the EVOH. The inventors surprisingly found out that a relatively poor alcoholic solvent such as ethylene glycol (EG) having a much higher solubility parameter dissolves EVOH in a multilayer waste polymer article to such extent that it may be removed from the article with high yield.

Although using an alcoholic solvent is essential to the invention, the addition of other solvents is not excluded, for instance in minor amounts relative to the alcoholic solvent, such as up to 50 wt. %, more preferably up to 30 wt. %, even more preferably up to 20 wt. %, and even more preferably up to 10 wt. %, relative to the amount of alcoholic solvent. Most preferably, no other solvent except for the alcoholic solvent is added to the solvent mixture. In some embodiments, an aprotic solvent may be added to the solvent mixture containing the alcoholic solvent. Suitable polar aprotic solvents that may be added comprise but are not limited to dichloromethane (DCM), tetrahydrofuran (THF), ethyl acetate, acetonitrile, dimethylformamide (DMF), dimethyl propylene urea, dimethyl acetamide (DMAc), dimethyl sulfoxide (DMSO), acetone, hexamethyl phosphoric triamide (HMPT), pyridine and sulfolane. Preferred polar aprotic solvents have a dielectric constant above 10, more preferably above 20 and most preferably above 30.

Step b) of the method also involves heating the solvent mixture to a temperature within the range from 90 to 170 °C until the EVOH polymer is at least partly dissolved. A preferred temperature is selected within the range from 100 °C to 165 °C, more preferably from 110 °C to 160 °C, even more preferably from 120 °C to 155 °C, and most preferably from 130 °C to 150 °C. A too low temperature may result in insufficient dissolution of EVOH in the alcoholic solvent, while a too high temperature may result in a premature depolymerization of the polyester. The indicated temperature ranges are further selected in view of an optimal recovery of the EVOH polymer from the mixture. The heating is typically performed for a period of 10 min to 8 h and more. The pressure during heating is typically from 90-200 kPa, such as atmospheric. The heating step results in the formation of a slurry comprising the polyester and dissolved EVOH. While at least a part of the EVOH is dissolved at the selected dissolving temperature and duration, the polyester does not substantially dissolve and remains substantially unaffected. It is preferred that the heating is carried out such that substantially all EVOH is dissolved. However, this is not deemed necessary. Minor amounts, for instance up to 10%, such as up to 5%, preferably up to 3% or even up to 1% by weight relative to the initial amount of EVOH may remain undissolved.

After the dissolution step b), the slurry is subjected to a solid-liquid separation in step c) of the method in which the polyester is separated from the solvent mixture which comprises the alcoholic solvent and the dissolved EVOH. Any suitable solid-liquid separation method may be used, such as centrifugation or filtering, or combinations of these. Typically, a step of filtering is performed over a crude filter thereby forming a filtrate. Herewith the polyester is separated from the solvent mixture by having the polyester remain on the filter, whereas the solvent mixture goes through the filter as a liquid and possibly in the form of small particles. The mesh size of the filter is preferably not too small in order to allow passage of the liquid, and not too large in order to retain the polyester. Typically, a step of filtering is performed over a filter with a mesh larger than 0.2 μm therewith forming a filtrate.

After collecting the filtrate that contains the solvent mixture, the EVOH present in the solvent mixture is precipitated in step d) of the invented method and then separated from the solvent mixture in a further step e) of the invented method. The mesh size in a filtration separation may be selected to retain most of the EVOH particles. Preferably, the mesh is larger than 0.2 μm, and an upper bound for mesh size may depend on the particle size of the EVOH particles, the latter being dependent on a number of variables such as the concentration of EVOH in the alcoholic solvent, cooling time, temperature, and possibly also water content of the alcoholic solvent. A suitable upper bound of mesh size may be easily selected by one skilled in the art, and may for instance be smaller than 20 μm. In addition to the mesh size, the used pressure may also play a role, whereby a larger underpressure typically allows for smaller mesh sizes. This embodiment is suitably carried out by providing the solvent mixture or slurry in a filtration chamber including the filter, wherein an underpressure is applied over the filter. The collected EVOH may then be processed further according to the needs.

A particularly useful embodiment of the invention provides a method that further comprises the step of reusing the used alcoholic solvent obtained in step e) at least partly in step b). In other words, the alcoholic solvent used to dissolve the EVOH is after separation reused in dissolving further EVOH. This may for instance be carried out in a container, such as a scrubber, to which container used alcoholic solvent is re-fed in addition to new feed of multilayer waste polymer material. Reusing the alcoholic solvent for dissolving newly fed EVOH actually increases the EVOH-concentration in the solvent mixture provided in step b), i.e. during contacting the waste polymer material in the size-reduced form with the alcoholic solvent. It has turned out that above a threshold concentration of EVOH in the solvent mixture, precipitation of EVOH from this solution is enhanced. The threshold concentration may depend on a number of factors but may be in the range of 20-30 mg/mL.

Another useful embodiment provides a method wherein precipitating the dissolved EVOH in the solvent mixture in step d) comprises cooling the solvent mixture to a temperature ranging from 1-100 °C, more preferably from 5-50 °C, even more preferably from 10-40 °C, and most preferably to a temperature at ambient pressure from 15-30 °C. In another embodiment, step d) may further comprise adding an anti-solvent such as water to the solvent mixture, which solvent mixture is according to yet a further embodiment cooled to a temperature below the contacting temperature of step b) before, during or after adding the anti-solvent such as water. It is not excluded that water is added as an aqueous solution, or as a mixture of alcohol and water.

In a further improved embodiment, the water (or aqueous solution) added has a temperature at ambient pressure from 1-100 °C, more preferably from 5-50 °C, even more preferably from 10-40 °C, and most preferably a temperature at ambient pressure from 15-30 °C. It has turned out that adding relatively cold water to the solvent mixture significantly improves the precipitation and the subsequent separation of the precipitated EVOH.

In order to improve the reusability of the used alcoholic solvent, an embodiment of the method is provided wherein the added water is separated from the used alcoholic solvent obtained in step e) before optionally reusing the alcoholic solvent according to step f). Since the boiling point of the added water will generally deviate from (and in most embodiments be lower than) the boiling point of the alcoholic solvent used in the method, this separation may be simply carried out by evaporation of the water for instance.

The amount of contaminants (such as minor amounts of another optional solvent besides the alcoholic solvent, or coloring agents such as titanium dioxide) that may still remain in the polyester after step c) may be reduced further by an embodiment of the method wherein the polyester obtained in step c) is washed in a suitable washing liquid, such as water or a polyalcohol. The washing or rinsing may be performed in one step or may be repeated in a number of steps, for instance by providing the polyester in a washing tank. In an embodiment, the washing may include friction washing. Washing may be important since small amounts of contaminants in the polyester may lead to discoloration in further downstream processes, such as in a process wherein the polyester is depolymerized into its monomers. Washing the polyester may also be advantageous when combined with an embodiment that further comprises the step of reusing the used alcoholic solvent obtained in step e) at least partly in step b). Re-use of the alcoholic solvent may lead to an increase of the EVOH-concentration in the solvent mixture, as was explained above, and may lead to some EVOH remaining in the polyester. Washing of the polyester effectively removes the EVOH completely or to a lower amount.

The waste polymer multilayer article may comprise several polymer materials. In a preferred embodiment, a method is provided wherein the waste polymer material comprises from 85-99 wt. % polyester, from 1-15 wt. % EVOH, and optionally polyolefin, the total adding up to 100 wt. %. According to an embodiment of the invention, the waste polymer material further comprises a polyolefin, preferably as distinct layer in a polymer multilayer article. The polyolefin preferably comprises polyethylene. This embodiment is advantageous in that the polyolefin may be separated from the polyester by density separation. A suitable process for achieving this is for instance disclosed in WO2021089809A1, herein incorporated by reference in its entirety.

In another embodiment of the method, the waste polymer material may further contain minor amounts of functional additives such as dyes, typically titanium dioxide. In such embodiment, the functional additives are dissolved in the alcoholic solvent and separated from the polyester in step d) with the alcoholic solvent.

The weight ratio of the alcoholic solvent relative to the waste polymer material may be varied between wide ranges but is preferably above 1:1. In a preferred embodiment, the weight ratio of waste polymer material to alcoholic solvent ranges from 1:2 to 1:40, more preferably from 1:5 to 1:35, more preferably from 1:10 to 1:25, and most preferably from 1:15 to 1:20. The lower ratios use less solvent and are therefore more preferred.

### Depolymerization of the Polyester

According to a second aspect of the invention, a preferred method further comprises the steps of adding a reactive solvent to disperse the polyester recovered after step c) and obtain a dispersion; adding a depolymerization catalyst to the dispersion; depolymerizing the polyester under conditions to obtain monomers and/or oligomers dissolved in the reactive solvent; wherein the reactive solvent comprises an alcoholic solvent, optionally the alcoholic solvent obtained from step e) of the method.

The depolymerization reaction is performed in a reactive solvent in which the polyester is dissolved, and is therefore referred to as solvolysis. The reactive solvent is selected to be a solvent for the polyester and/or for reaction products obtained from the polyester by depolymerization. Such reactive solvents are known to the person skilled in the art. In the context of the invention, the wording reactive solvent also encompasses mixtures of a solvent that is reactive per se and a non-reactive solvent. Depolymerization of polyesters by solvolysis is typically performed in alcoholic solvents, typically in alkanols, alkanediols, alkanetriols or combinations thereof. Non-limiting examples of the alkanols, alkanediols and alkanetriols are methanol, ethylene glycol, diethylene glycol, propylene glycol, dipropylene 15 glycol, 1,4-butanediol, 1,5-pentanediol and glycerol. Ethylene glycol has been found suitable in view of its physical properties (such as its boiling point around 200 °C). In case of depolymerization of PET, the use of ethylene glycol leads to bis(2-hydroxyethyl) terephthalate (BHET) as primary depolymerization product. Dimers, trimers and further oligomers may also be obtained.

For depolymerization, the waste polymer material, now comprising substantially polyester, is preferably loaded into a reactor vessel in a weight ratio with the reactive alcoholic solvent in the range of 2:1 to 1:10, more preferably in a weight ratio in the range of 1:2 to 1:9, even more preferably in a weight ratio in the range of 1:4 to 1:8. It should be noted that a third polymer, such as polyolefin, polyamide or polystyrene, may not have been dissolved in step c) of the method and is still present in the dispersion (also referred to as the reaction mixture) in which the depolymerization takes place.

In an embodiment, the waste polymer material, the reactive solvent and optionally a catalyst are supplied to the reactor vessel. The reaction mixture is heated to a temperature of at least 150 °C, wherein the waste polymer material is heated as part of the reaction mixture and the optional third polymer other than the polyester is molten or may remain in substantially solid form. This heating step serves to dissolve at least part of the polyester present in the waste material in the reactive solvent in order to be able to start the depolymerization reaction. As a result of the heating step, the optional third polymer other than the polyester polymer may melt. In particular, polyolefins, such as polypropylene and polyethylene, typically have a melting temperature in the range of 100 to 140 °C. Other third polymers such as some grades of polyamides or polystyrene may partly dissolve or remain substantially solid. The third polymer may be removed from the reaction mixture by a density separation.

It should be mentioned that the waste polymer material may further comprises a chlorine-containing polymer, albeit is relatively small quantities. Indeed, polyvinylchloride (PVC) may be used in multilayer articles for its mechanical stability and as a gas barrier, while polyvinylidenechloride (PVDC) may act as an oxygen and moisture barrier. It has been found out by the inventors that in case the waste polymer material comprises a chlorine-containing polymer, a base such as sodium hydroxide (NaOH) is advantageously added in at least one of the steps a) to e) of the method, and/or in the optional depolymerization steps.

One preferred way of depolymerization is glycolysis, which is preferably catalyzed. Typically, as a result of the preferred use of ethylene glycol, a reaction mixture comprising at least one monomer comprising bis(2-hydroxyethyl) terephthalate (BHET) may be formed. A polymer concentration in the reaction mixture or dispersion before depolymerization is typically from 1-30 wt. % of the total weight of the reaction mixture, although concentrations outside this range may also be possible. One example of a suitable depolymerization by glycolysis is known from WO2016/105200 in the name of the present applicant. According to this process, the terephthalate polymer is depolymerized by glycolysis in the presence of a specially designed catalyst. At the end of the depolymerization process, water is added, and a phase separation occurs. This enables to separate a first phase comprising the BHET monomer from a second phase comprising catalyst, oligomers, and additives. The first phase may comprise impurities in dissolved form and as dispersed particles. The BHET monomer may then be obtained by means of crystallization.

A high purity is required for the depolymerized raw material to be reusable in repolymerization. As is well-known, any contaminant may have an impact on the subsequent polymerization reaction from the raw materials. Moreover, since terephthalate polymers are used for food and also medical applications, strict rules apply so as to prevent health issues. The present invention allows achieving such a high purity.

The reaction mixture may be heated to a suitable temperature which is preferably maintained during depolymerization. The depolymerization may be carried out at a temperature of at least 160 °C, preferably of at least 180 °C, more preferably of at least 190 °C. The temperature may conveniently be selected in the range of from 160 °C to 250 °C. More preferably, the depolymerization step may comprise forming the monomer at a temperature in the range of from 185 °C to 225 °C. Suitable pressures in a depolymerization reactor are from 1-5 bar, wherein a pressure higher than 1.0 bar is preferred, and more preferably lower than 3.0 bar.

An average residence time of the polyester and its monomers, dimers and oligomers during the depolymerization step may range from 30 sec-3 hours, and longer. In order to stop the depolymerization reaction and/or deactivate the catalyst, the temperature may be reduced to a temperature below 160 °C or lower, but preferably not lower than 85 °C.

### The Catalyst System

The invention may be carried out using any catalyst suitable for the purpose. Suitable catalysts include heterogeneous catalysts. In a depolymerization method according to an embodiment, the catalyst then forms a dispersion in the reaction mixture. Other suitable catalysts include homogeneous catalysts. These do not form a dispersion but are typically dissolved in the reaction mixture.

Several of the possible heterogeneous depolymerization catalysts are based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as magnetite, hematite, and maghemite can be used. The catalyst particles may comprise nanoparticles.

The catalyst particles catalyze the depolymerization reaction. In this depolymerization reaction individual molecules of the condensation polymer are released via a catalytic reaction out of the solid polymer, which polymer is for instance semi-crystalline. This release results in dispersing of polymer material into the reactive solvent and/or dissolving of individual polymer molecules in the reactive solvent. Such dispersing and/or dissolving is believed to further enhance depolymerization from polymer into monomers and oligomers.

One class of suitable catalysts includes the transition metals, in their metallic or ionic form. The ionic form includes free ions in solutions and in ionic bonds or covalent bonds. Ionic bonds form when one atom gives up one or more electrons to another atom. Covalent bonds form with interatomic linkage that results from the sharing of an electron pair between two atoms. The transition metal may be chosen from the first series of transition metals, also known as the 3d orbital transition metals. More particularly, the transition metal is chosen from iron, nickel and cobalt. Since cobalt however is not healthy and iron and nickel particles may be formed in pure form, iron and nickel particles are most preferred. Furthermore, use can be made of alloys of the individual transition metals.

If a catalytic particle is made of metal, it may be provided with an oxide surface, which may further enhance catalysis. The oxide surface may be formed by itself, in contact with air, in contact with water, or the oxide surface may be applied deliberately.

Most preferred is the use of iron containing particles. Besides that iron containing particles are magnetic, they have been found to catalyze the depolymerization of PET for instance to conversion rates into monomer of 70-90% within an acceptable reaction time of at most 6 hours, however depending on catalyst loading and other processing factors such as the PET/solvent ratio.

Non-porous metal particles, in particular transition metal particles, may be suitably prepared by thermal decomposition of carbonyl complexes such as iron pentacarbonyl and nickel tetracarbonyl. Alternatively, iron oxides and nickel oxides may be prepared via exposure of the metals to oxygen at higher temperatures, such as 400 °C and above. A non-porous particle may be more suitable than a porous particle, since its exposure to the alcohol may be less, and therefore, the corrosion of the particle may be less as well, and the particle may be reused more often for catalysis. Furthermore, due to the limited surface area, any oxidation at the surface may result in a lower quantity of metal-ions and therewith a lower level of ions that are present in the product stream as a leached contaminant to be removed therefrom.

Another class of suitable catalysts includes particles based on earth alkali elements selected from beryllium (Be), magnesium (Mg), calcium (Ca), strontium (Sr) and barium (Ba), and their oxides. A preferred earth alkali metal oxide is magnesium oxide (MgO). Other suitable metals include but are not limited to titanium (Ti), zirconium (Zr), manganese (Mn), zinc (Zn), aluminum (Al), germanium (Ge) and antimony (Sb), as well as their oxides, and further alloys thereof. Also suitable are precious metals, such as palladium (Pd) and platinum (Pt). MgO and ZnO have been found to catalyze the depolymerization of PET for instance to conversion rates into monomer of 70-90% within an acceptable reaction time, however depending on catalyst loading and other processing factors such as the PET/solvent ratio. Suitable catalysts based on hydrotalcites are also considered.

Preferably, the catalyst particles are selected so as to be substantially insoluble in the (alcoholic) reactive solvent, also at higher temperatures of more than 100 °C. Oxides that readily tend to dissolve at higher temperatures in an alcohol such as ethylene glycol, such as for instance amorphous SiO₂, are less suited.

The preferred concentration of catalyst is 1 wt % relative to the amount of PET or less. Good results have also been achieved with a catalyst loading below 0.2 wt % and even below 0.1 wt % relative to the amount of PET. Such a low loading of the catalyst is highly beneficial, and the invented method allows recovering an increased amount of the nanoparticle catalyst.

Non-porous particles according to the invention have a surface area suitably less than 10 m²/g, more preferably at most 5 m²/g, even more preferably at most 1 m²/g. In another embodiment, the surface area is at least 3 m²/g. The porosity is suitably less than 10⁻² cm³/g or for instance at most 10⁻³ cm³/g. Porous particles may also be used, generally exhibiting a larger surface area.

In a depolymerization method according to an embodiment, the catalyst forms a dispersion in the reaction mixture during mixing and/or depolymerization. A particularly preferred heterogeneous catalyst that may be used in the invention is a catalyst complex comprising catalyst particles and a catalyst entity that is associated with the catalyst particles, for instance attached thereto via a linking group. The catalyst entity comprises an ionic liquid comprising a cationic moiety having a positive charge and an anionic moiety having a negative charge. The catalyst particles are preferably nanoparticles, and more preferably magnetic particles and the latter are preferably used in a method wherein the recovering step of said catalyst is carried out using a magnetic force of attraction between a magnet and said particles. The catalyst particles in themselves may also exhibit catalytic activity.

The catalyst complex (ABC) comprises three distinguishable elements: a (nano) particle (A), a bridging moiety comprising a linking group (B) attached to the particle chemically, such as by a covalent bond, or physically, such as by adsorption, and a catalyst entity (C) that is associated with the particles (A), such as by being chemically bonded, for instance covalently bonded, to the linking group. The linking group preferably does not fully cover the nanoparticle surface, such as in a core-shell particle. In the remaining disclosure this catalyst may also be referred to as MF.

The particles of the claimed catalyst complex are preferably based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as hematite (Fe₂O₃), magnetite (Fe₃O₄), and maghemite (Fe₂O₃, γ-Fe₂O₃) may be used. In view of costs, even when fully or largely recovering the present catalyst complex, relatively cheap particles are preferred, such as particles comprising iron (Fe). A further advantage of particles of iron or iron oxides is that they have highest saturation magnetisation, making it easier to separate the particles via a magnetic separator. And even more importantly, the iron oxide (nano) particles have a positive impact on the degradation reaction. The iron oxide may further contain additional elements such as cobalt and/or manganese, for instance CoFe₂O₄.

The catalyst particles that are used in the catalyst complex according to the invention may be coated at least partly with a protective coating. The coating may further serve to stabilize the catalyst in that the particles remain in suspension. Thus, at least a part of the surface of the catalyst particles may be coated with materials such as polyethyleneimine (PEI), polyethylene glycol (PEG), silicon oil, fatty acids like oleic acid or stearic acid, silane, a mineral oil, an amino acid, or polyacrylic acid or, polyvinylpyrrolidone (PVP). Carbon is also possible as a coating material. The coating may be removed before or during the catalytic reaction. Ways to remove the coating may for instance comprise using a solvent wash step separately before using it in the reactor, or by burning in air. Removal of the coating, however, is not essential.

Preferably, the catalyst particles are selected to be substantially insoluble in the (alcoholic) reactive solvent, also at higher temperatures of more than 100 °C. Oxides that readily tend to dissolve at higher temperatures in an alcohol such as ethylene glycol, such as for instance amorphous SiO₂, are less suited.

It has been found that the catalyst particles preferably are sufficiently small for the catalyst complex to function as a catalyst, therewith degrading the terephthalate polymer into smaller units, wherein the yield of these smaller units and specifically the monomers thereof, is high enough for commercial reasons. It has further been found that the nanoparticles preferably are sufficiently large in order to be able to reuse the present complex by recovering the present catalyst complex. Suitable catalyst particles have an average diameter of larger than 1 μm up to 3 μm and larger. Suitable nanoparticles have an average diameter of 2-500 nm, and even larger up to 1 μm.

In an example of the present catalyst complex the magnetic particles have an average diameter of 2 nm-500 nm, preferably from 3 nm-100 nm, more preferably from 4 nm-50 nm, such as from 5-10 nm. It has been found that e.g., in terms of yield and recovery of catalyst complex a rather small size of particles of 5-10 nm is optimal. It is noted that the term “size” relates to an average diameter of the particles, wherein an actual diameter of a particle may vary somewhat due to characteristics thereof. In addition, aggregates may be formed e.g. in the solution. These aggregates typically have sizes in a range of 50-200 nm, such as 80-150 nm, e.g. around 100 nm.

Particle sizes and a distribution thereof can be measured by light scattering, for instance using a Malvern Dynamic light Scattering apparatus, such as a NS500 series. In a more laborious way, typically applied for smaller particle sizes and equally well applicable to large sizes, representative electron microscopy pictures are taken, and the sizes of individual particles are measured on the picture. For an average particle size, a number average may be taken. In an approximation the average may be taken as the size with the highest number of particles or as a median size.

The present catalyst entity comprises at least two moieties. A first moiety relates to a moiety having a positive charge (cation). A second moiety relates to a moiety, typically a salt complex moiety, having a negative charge (anion). The negative and positive charges typically balance one another. It has been found that the positively and negatively charged moieties have a synergistic and enhancing effect on the degradation process of waste terephthalate polymer in terms of conversion and selectivity.

The positively charged moiety (cation) may be aromatic or aliphatic, and/or heterocyclic. The cationic moiety may be aliphatic and is preferably selected from guanidinium (carbamimidoylazanium), ammonium, phosphonium and sulphonium. A non-aromatic or aromatic heterocyclic moiety preferably comprises a heterocycle, having at least one, preferably at least two hetero-atoms. The heterocycle may have 5 or 6 atoms, preferably 5 atoms. The positively charged moiety may be an aromatic moiety, which preferably stabilizes a positive charge. Typically, the cationic moiety carries a delocalized positive charge. The hetero-atom may be nitrogen N, phosphor P or sulphur S for instance. Suitable aromatic heterocycles are pyrimidines, imidazoles, piperidines, pyrrolidine, pyridine, pyrazol, oxazol, triazol, thiazol, methimazol, benzotriazol, isoquinol and viologen-type compounds (having f.i. two coupled pyridine-ring structures). Particularly preferred is an imidazole structure, which results in an imidazolium ion. Particularly suitable cationic moieties having N as hetero-atom comprise imidazolium, (5-membered ring with two N), piperidinium (6-membered ring with one N), pyrrolidinium (5-membered ring having one N), and pyridinium (6-membered ring with one N). Preferred imidazolium cationic moieties comprise butylmethylimidazolium (bmim⁺), and dialkylimidazoliums. Other suitable cationic moieties include but are not limited to triazolium (5-membered ring with 3 N), thiazolidium (5-membered ring with N and S), and (iso) quiloninium (two 6-membered rings (naphthalene) with N).

In a preferred method, the cationic moiety of the catalyst entity is selected from at least one of an imidazolium group, a piperidinium group, a pyridinium group, a pyrrolidinium group, a sulfonium group, an ammonium group, and a phosphonium group.

Said cationic moiety may have one or more substituents, which one or more substituents is preferably selected an alkyl moiety. In particular examples, said alkyl moiety has a length of C₁-C₆, such as C₂-C₄. In specific examples, said imidazolium group has two substituents R₁, R₂ attached to one of the two nitrogen atoms, respectively, said piperidinium group has two substituents R₁, R₂ attached to its nitrogen atom, said pyridinium group has two substituents R₁, R₂ wherein one of the two substituents R₁, R₂ is attached to its nitrogen atom, said pyrrolidinium group has two substituents R₁, R₂ attached to its nitrogen atom, said sulphonium group has three substituents R₁, R₂, R₃ attached to its sulphur atom, said ammonium group has four substituents R₁, R₂, R₃, R₄ attached to its nitrogen atom, and said phosphonium group has four substituents R₁, R₂, R₃, R₄ attached to its phosphor atom, respectively.

The negatively charged moiety (anion) may relate to an anionic complex, but alternatively to a simple ion, such as a halide. It may relate to a salt complex moiety, preferably a metal salt complex moiety, having a two- or three-plus charged metal ion, such as Fe³⁺, Al³⁺, Ca²⁺, Zn²⁺ and Cu²⁺, and negatively charged counter-ions, such as halogenides, e.g. Cl⁻, F⁻, and Br⁻. In an example the salt is a Fe³⁺ comprising salt complex moiety, such as an halogenide, e.g. FeCl₄⁻. Alternatively, use can be made of counter-ions without a metal salt complex, such as halides as known per se.

The linking group may comprise a bridging moiety for attaching the catalyst entity to the catalyst particle. The present catalyst entity and particle are combined by the bridging moiety by attaching the catalyst entity to the catalyst particle. The attachment typically involves a physical or chemical bonding between a combination of the bridging moiety and the catalyst entity on the one hand and the catalyst particle on the other hand. Particularly, a plurality of bridging moieties is attached or bonded to a surface area of the present catalyst particle. Suitable bridging moieties comprise a weak organic acid, silyl comprising groups, and silanol. More particularly, therefore, the bridging moiety comprises a functional group for bonding to the oxide of the particle and a second linking group for bonding to the catalyst entity. The functional group is for instance a carboxylic acid, an alcohol, a silicic acid group, or combinations thereof. Other acids such as organic sulphonic acids are not excluded. The linking group comprises for instance an end alkyl chain attached to the cationic moiety, with the alkyl chain typically between C₁ and C₆, for instance propyl and ethyl. The linking group may be attached to the cationic moieties such as the preferred imidazolium moiety. In the attached state, a BC complex then for instance comprises imidazolium having two alkyl groups, such as butylmethylimidazolium (bmim+) or ethylmethylimidazolium as an example.

The bridging moiety is suitably provided as a reactant, in which the linking group is functionalized for chemical reaction with the catalyst entity. For instance, a suitable functionalization of the linking group is the provision as a substituted alkyl halide. Suitable reactants for instance include 3-chloropropyltrialkoxysilane and 3-bromopropyltrialkoxysilane. The alkoxy-group is preferably ethoxy, although methoxy or propoxy groups are not excluded. It is preferred to use trialkoxysilanes, although dialkyldialkoxysilanes and trialkyl-monoalkoxysilanes are not excluded. In the latter cases, the alkyl groups are preferably lower alkyl, such as C₁-C₄ alkyl. At least one of the alkyl groups is then functionalized, for instance with a halide, as specified above.

The said reactant is then reacted with the catalyst entity. Preferably, this reaction generates the positive charge on the cationic moiety, more particularly on a hetero-atom but mostly delocalized, in the, preferably heterocyclic, cationic moiety. The reaction is for instance a reaction of a (substituted) alkyl halide with a hetero-atom, such as nitrogen, containing cationic moiety, resulting in a bond between the hetero-atom and the alkyl-group. The hetero-atom is therewith charged positively, and the halide negatively. The negatively charged halide may thereafter be strengthened by addition of a Lewis acid to form a metal salt complex. One example is the conversion of chloride to FeCl₄⁻.

According to the present invention, the bridging moiety and the catalyst entity bonded thereto are provided in an amount of (mole bridging moiety/gr magnetic particle) 5*10⁻⁶-0.1, preferably 1*10⁻⁵-0.01, more preferably 2*10⁻⁵-10⁻³, such as 4*10⁻⁵-10⁻⁴. It is preferred to have a relatively large amount available in terms of an effective optional recovery of the catalyst complex, whereas, in terms of amount of catalyst and costs thereof, a somewhat smaller amount may be more preferred.

Notably, homogeneous catalysts are more difficult to recover from the product stream. It may even be impossible to recover such catalysts. However, it could for instance be possible to recover them prior to crystallisation of the BHET monomer, but this would require specific measures to overcome issues. The use of heterogeneous catalysts in embodiments of the invented method is therefore preferred.

The catalyst may in preferred embodiments be used in a ratio of 0.001-20 wt. %, more preferably 0.01-10 wt. %, and most preferably 0.01-5 wt. %, relative to the polymer weight.

### CONCLUSION

The present invention provides an efficient method of recovering EVOH, and optionally other polymers such as polyolefins, from a waste multilayer polymer material that comprises polyester, such as PET, and EVOH. The method is relatively robust, substantially insensitive to the presence of additives and impurities, and preferably makes use of one type of solvent only. As such, the present method is especially suited for waste multilayer polymer articles, such as MLT for instance. Moreover, the remaining polyester is ready for further processing and particularly depolymerization because remaining substances such as polymer, degraded polymer and solvents are effectively removed before such further processing.

The present invention may in embodiments also provide a BHET monomer after depolymerization with a relatively high purity. A high purity in the context of the present invention may mean a relatively low amount of contaminants and/or a relatively low amount of EVOH polymer present in the BHET monomer after pre-treatment and depolymerization.

The invention is further detailed by the examples, which are exemplary and explanatory of nature and are not limiting the scope of the invention. To the person skilled in the art, it may be clear that many variants, being obvious or not, may be conceivable falling within the scope of protection, defined by the appended claims. In the accompanying figures,

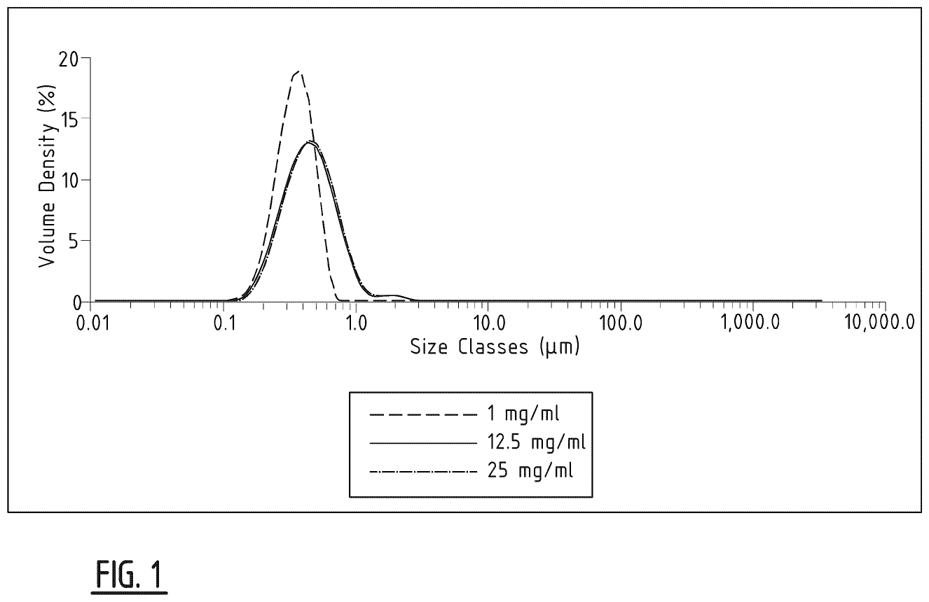

FIG. 1 schematically shows the particle size distribution of dissolved EVOH at different concentrations of EVOH in ethylene glycol;

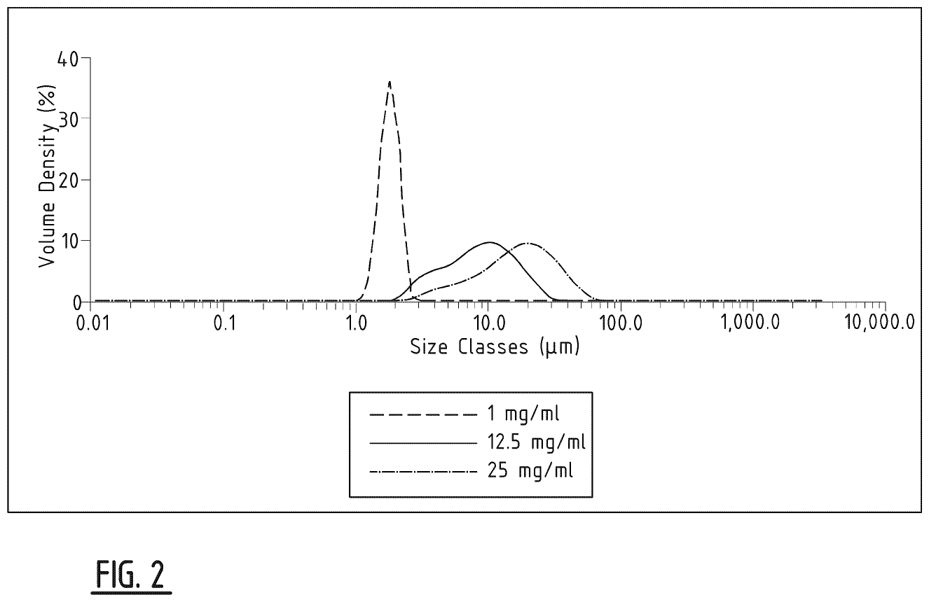

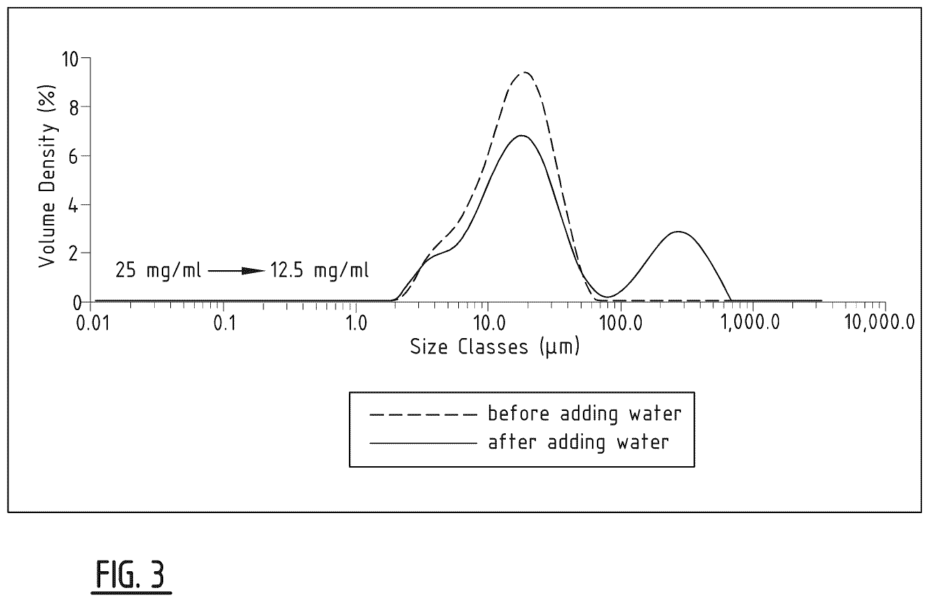

FIG. 2 schematically shows the particle size distribution of dissolved EVOH at different concentrations of EVOH in ethylene glycol after two days of sedimentation without agitation; and FIG. 3 schematically shows the particle size distribution of dissolved EVOH for a concentration of EVOH in ethylene glycol of 25 mg/mL before and after adding water during precipitation.

### EXAMPLES

### Materials and Methods

### Initial Waste Material

Samples of laminated waste material (MLT) contained an outer layer of PET, an outer layer of PE and an intermittent layer of EVOH. The average thickness of the PET layers was 469 μm, the average thickness of the PE layers was 47 μm, and the average thickness of the EVOH layers was 8 μm, summing up to an average total thickness of the laminates of 524 μm. This results in the following composition of the MLT: 92.5 wt. % PET, 1.3 wt. % EVOH and 6.2 wt. % PE. The PET layer is meant to provide stiffness to the MLT, while the PE is meant to provide a moisture barrier, and the EVOH to provide an oxygen barrier to the MLT. When recycled, the waste MLT is typically shredded in a mechanical recycler that produces pieces or flakes of cut material. Some fines may also be present. The shredding typically does not facilitate separation of the different layers (delamination) as these different layers tend to be adhered to each other rather strongly.

### Additional Materials Used

Ethylene glycol (EG) as alcoholic solvent was obtained from Sigma-Aldrich.

Poly (vinyl alcohol-co-ethylene) with CAS No. 25067-34-9 was obtained from Sigma Aldrich.

A catalyst complex comprising an iron particle (A), a bridging moiety comprising a linking group (B) attached to the particle and a catalyst entity (C) that is associated with the particle (A) (also referred to as MF catalyst) was used in the depolymerization experiments.

### EVOH Solubility Experiments

To test the solubility of EVOH in EG, several mixtures of EG with different concentrations of EVOH were prepared. To a 500 ml beaker, 200 mL or 222 g of EG was added. Depending on the concentration required, 100, 200, 1000, 3000, 5000 or 10000 mg of EVOH were added to the EG resulting in concentrations of 0.5, 1, 5, 15, 25 or 50 mg/mL. The reaction mixtures were put on a heater and heated to around 150 °C while stirring with a magnetic stirring bar. The EVOH particles slowly dissolved and became sticky. After 2 to 3 hours, substantially all of the EVOH particles were dissolved in the EG. The heating temperature of the heating plate should not be higher than about 250 °C to avoid EVOH particles to burn when stuck to the bottom of the beaker.

### Mastersizer Measurements

To measure the particle size of precipitated EVOH in a mixture, Mastersizer analyses were performed using a Malvern Mastersizer 3000. To prepare the measurement, the measurement cell and circulation system were cleaned with EG and water. Afterwards, 100 mL of EG was added to the circulation system and was run at 2400 rpm stirring for a couple of minutes until all air bubbles were removed. A background measurement was then performed in order to make the system ready for measurement. Once ready, an EG/EVOH solution was added to the circulation system until the right obscuration was reached (around 8 to 12%). The amount of sample added ranged between a couple of drops or a couple of mL, depending on the concentration of the sample. A measurement with standard settings (5 measurements with blue and red laser) was performed to obtain the particle size distribution of the EVOH particles. After the measurement, the system was properly cleaned with water and EG.

### EXPERIMENTS

### Example 1: Influence of EVOH on Reaction Kinetics of PET Depolymerization

To a 250 ml RBF, 125 g of EG, 16.7 g of PET shredded flakes, obtained from transparent PET bottle feedstock, and 0.017 g of MF catalyst were added. A depolymerization reaction mixture was thus obtained in a ratio of 0.01 MF: 1 PET: 7.5 EG. To this reaction mixture an EVOH copolymer was added to the RBF in an amount of 10 wt. % EVOH (related to the amount of PET) or 1.67 g. Please note that this amount may be much higher than typically encountered in MLT for instance. EVOH is a copolymer with different ratios of alcohol and ethylene parts, as shown below:

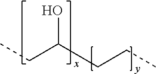

The ratio influences its properties in that a lower ethylene content generally may have higher barrier properties, while a higher ethylene content generally favors extrusion at lower temperatures. The invention is not limited to a specific type of EVOH but an EVOH with y=32 mol % was used in this Example. This grade also seems commonly used in MLT.

The RBF was then placed in a depolymerization setup with reflux condenser and was heated until a reflux temperature of 197 °C. Stirring was performed at 300 rpm and the reaction mixture was left to react for 4 hours. After depolymerization of the PET, the reaction mixture was cooled down to 120-140 °C and poured over a tea sieve to collect remnants. Boiling water was added in a 50/50 wt. %/wt. % ratio and the reaction mixture was centrifuged to remove at least part of the MF catalyst. By weighing the sediment, it was found that not all EVOH was separated via centrifugation.

From the results, it may be inferred that EVOH does not seem to influence PET depolymerization kinetics using the MF catalyst. Moreover, EVOH readily dissolved in hot EG.

The excellent dissolution of EVOH in EG may result in a showing up of EVOH in the further downstream process of a depolymerization process of PET based on glycolysis, which is not generally desirable. The invention makes use of the observation that EVOH dissolves well in hot EG and provides an efficient solution for removing EVOH from the reaction mixture, as will be shown in more detail below.

### Example 2: EVOH Solubility in EG and after Addition of Water

EVOH is a sticky polymer when partially dissolved and in contact with water, which poses severe challenges in terms of fouling of process equipment. Sticky behavior is typically less desired in industrial processes since it may lead to fouling of parts of the equipment used and other problems.

In Example 2, solubility of EVOH in EG was examined in order to predict when complete solubility of EVOH in EG could be achieved. When substantially dissolved, stickiness is less of an issue.

EVOH granules of the type used in Example 1 were dissolved in EG in an amount of 10 wt. % at different temperatures and for different time durations. It was noted that EVOH dissolved rather well in EG at temperatures above 120-130 °C. Upon cooling of the EVOH/EG mixture to room temperature, a turbid mixture developed which is indicative of precipitation of the EVOH in the EVOH/EG mixture. In another experiment, demineralized water was added to the EVOH/EG mixture in a 50/50 wt. % ratio at a temperature of about 80-90 °C addition. After cooling down the EVOH/EG mixture to room temperature, a turbid mixture developed which indicates that the EVOH precipitated in the mixture. From these results, it may be observed that EG is an excellent solvent to dissolve EVOH while demineralized water acts as an antisolvent.

### Example 3: Pre-Treatment of MLT Consisting of PET/EVOH/PE

The MLT disclosed under heading ‘Initial waste material’ above was cut into flakes and 5 g of these flakes were provided in 100 ml EG at different temperatures (130 °C, 150 °C and 170 °C) for 4 hours under slow stirring. Higher temperatures were not tested for the pre-treatment because the PET might start to depolymerize at these conditions. In an experiment, it was noted that only 0.12 wt. % BHET formed during EVOH extraction at 170 °C after 5 hours.

Delamination of the MLT flakes was observed at 130 °C and to an increasing extent for the 150 °C and 170 °C temperature tests. A mass of PE developed and tended to float on top of the mixture at all temperatures. Some PE was observed to accumulate around the stirrer. PE was separated from the mixture since it did not substantially dissolve in EG and tended to float on top of the mixture, due to its lower density.

Upon cooling of the EVOH/EG mixture to room temperature, a turbid mixture developed which is indicative of precipitation of the EVOH in the mixture. In another experiment, water was added to the EVOH/EG mixture in a 50/50 wt. % ratio at a temperature of about 80-90 °C. After cooling down to room temperature, a turbid mixture was obtained. From these results, it may be observed that EG is an excellent solvent to dissolve EVOH while water acts as an antisolvent. Precipitation of EVOH was noted in the presence of water, even after heating up to 100 °C.

PET flakes were obtained by solid/liquid separation (filtration) of the EVOH/PE/PET/EG mixture. DSC and FTIR were measured for the separated PET fractions of one pre-treatment performed at 170 °C. The results showed that no EVOH was left with only some PE left behind on the PET flakes that curled up. PE was observed to float on the EVOH/PE/PET/EG mixture. Since no EVOH was found in the DSC and FTIR traces, it was substantially completely dissolved in the EG.

Finally, some MLT flake samples were shown to curl heavily during the pre-treatment. This curling may hinder the PE from fully detaching from the PET and EVOH layers. One skilled in the art however will be able to adjust parameters such as flake type (different thicknesses), heating rate, flake size, stirring speed and starting temperature by routine experimentation to control the degree of curling below a threshold degree.

### Example 4: EVOH Recovery from EG

The invented method causes precipitation of EVOH in the reaction mixture. Step e) of the method involves separating the precipitated EVOH (or vinyl alcohol copolymer in general) from EG (or the solvent mixture in general) to EVOH and used EG solvent. The EG that is rich in EVOH after the extraction is preferably purified for the process to be economically viable. Indeed, the used alcoholic solvent may then be reused at least partly in step b) of the invented method.

Since it was shown that the EG/EVOH mixture turns turbid after cooling down to room temperature, and the addition of water makes this process even more pronounced, precipitation and/or agglomeration followed by size-based separation is a preferred way forward for separation. Since precipitation of EVOH is possible in pure EG, this is preferred over the addition of water.

To investigate at which temperature EVOH in EG starts to dissolve or starts to show turbidity, various solutions of different concentrations of EVOH in EG were prepared (concentrations of 1, 5, 10, 15, 20 and 25 mg/ml were used). After dissolving the EVOH in EG at 150 °C, the mixtures were cooled down for a first cycle and the temperature at which turbidity was observed was noted.

The turbid mixtures were heated again and became substantially fully transparent at ~80 °C. A second cooling cycle was then performed to again observe the temperature at which turbidity would occur. These results showed that in all tested concentrations of EVOH in EG turbidity was observed at a similar temperature upon cooling. From these experiments, it may also be concluded that the temperature of cooling should preferably be below 30 °C in order for precipitation to occur to a large extent.

A size-based isolation of EVOH particles from the EVOH/EG mixture therefore is preferably executed below such a temperature.

The particle sizes were measured with the Mastersizer, referred to above. Initially, three concentrations were prepared for the Mastersizer as a starting point. The three samples had 1 mg/mL, 12.5 mg/mL and 25 mg/mL of EVOH in EG respectively. The initial particle size distribution for the three samples is shown in FIG. 1.

Sedimentation of the EVOH particles was observed in all samples, and in particular in the samples with 12.5 and 25 mg/mL after two days standing without any agitation. This is shown in FIG. 2.

The samples were centrifuged at 4000 rpm for 3 min and sediment was isolated for the 12.5 and 25 mg/ml concentrations. The samples were again centrifuged under the same conditions after addition of water (50/50 wt. %). FIG. 3 shows that the addition of water increases the observed particle sizes. This finding was also confirmed by optical spectroscopy.

The precipitated EVOH/EG solutions were filtrated in a Buchner set-up with a 12-15 μm paper filter, subsequently washed with water several times, and dried. Filtration proved to be successful as a solid/liquid separation method, as indicated by a cake that readily formed on the filter. The obtained filtrate looked clear. Besides the concentration of EVOH and the time, it was observed that cooling rate may also play a role in precipitation.

### Filtration Efficiency Tests

Filtration efficiency was measured in an indicative manner for 4 different cooling methods of a 25 mg/mL EVOH in EG solution. The amount of liquid that was poured over the filter was weighted as well as the amount of solids that was left on the filter after filtration. The results are shown in Table 1 below.

TABLE 1
filtration efficiencies

| Sample | Filtration efficiency |
|---|---|
| 1: stirring for 5 days | 90% |
| 2: stirring only while cooling | 75% |
| 3: no stirring | 90% |
| 4: crash cooling to RT while cooling | 90% |

Filtration efficiencies ranged from about 75 up to 90% and more. Crash cooling of the EVOH/EG solution and no or limited stirring seemed to provide the highest filtration efficiencies in separating EVOH from EG.

In another experiment, a solution with 25 mg/mL EVOH in EG was divided in two parts. One part was centrifuged and filtered, whereas another part was immediately filtered. The solid material obtained after centrifugation and filtering was 85%, whereas the solid material obtained after immediate filtration was 98%. From this experiment, it appears that filtration seems to be more efficient than centrifugation, or combined centrifugation and filtration.

The invention has been described by reference to certain embodiments discussed above. It will be recognized that these embodiments are susceptible to various modifications and alternative forms well known to those skilled in the art.

1. A method of removing ethylene vinyl alcohol copolymer from a waste polymer material that comprises polyester and ethylene vinyl alcohol copolymer, the method comprising the steps of:
a) providing the waste polymer material in a size-reduced form;
b) contacting the waste polymer material in the size-reduced form with an alcoholic solvent at a temperature from 90 °C to 170 °C to dissolve the ethylene vinyl alcohol copolymer at least partly in the alcoholic solvent while the polyester remains substantially unaffected;
c) separating the polyester from the solvent mixture comprising the alcoholic solvent and the vinyl alcohol copolymer dissolved therein by solid-liquid separation;
d) precipitating the dissolved vinyl alcohol copolymer in the solvent mixture; and
e) separating the precipitated vinyl alcohol copolymer from the solvent mixture to obtain vinyl alcohol copolymer and used alcoholic solvent.

2. The method as claimed in claim 1, further comprising the step of reusing the used alcoholic solvent obtained in step e) at least partly in step b).

3. The method as claimed in claim 1, wherein precipitating the dissolved vinyl alcohol copolymer in the solvent mixture in step d) comprises cooling the solvent mixture to a temperature ranging from 1 °C-100 °C, more preferably from 5 °C-50 °C, even more preferably from 10 °C-40 °C, and most preferably to a temperature at ambient pressure from 15 °C-30 °C.

4. The method as claimed in claim 3, wherein water is added to the solvent mixture in step d).

5. The method as claimed in claim 4, wherein the water added has a temperature from 1 °C-100 °C at ambient pressure, more preferably from 5 °C-50 °C at ambient pressure, even more preferably from 10 °C-40 °C, and most preferably from 15 °C-30 °C at ambient temperature.

6. The method as claimed in claim 4, wherein the added water is separated from the used alcoholic solvent obtained in step e) before the optional reuse of the alcoholic solvent according to step f).

7. The method as claimed in claim 1, further comprising adding a reactive solvent to disperse the polyester and obtain a dispersion; adding a depolymerization catalyst to the dispersion; and depolymerizing the polyester under conditions to obtain monomers and/or oligomers dissolved in the reactive solvent, wherein the reactive solvent comprises an alcoholic solvent, preferably at least a part of the used alcoholic solvent.

8. The method as claimed in claim 1, wherein the waste polymer material further comprises a chlorine-containing polymer, and a base is added to the solvent mixture in at least one of the steps a) to e) and/or to the reaction mixture in depolymerizing the polyester.

9. The method as claimed in claim 1, wherein the waste polymer material comprises a multi-layer tray, optionally further comprising a polyolefin.

10. The method as claimed in claim 9, wherein the polyolefin is separated from the polyester by density separation.

11. The method as claimed in claim 1, wherein the waste polymer material further contains functional additives such as dyes, and the functional additives are dissolved in the alcoholic solvent and separated from the polyester in step c) with the alcoholic solvent.

12. The method as claimed in claim 1, wherein the alcoholic solvent comprises a glycol, more preferably an alkylene glycol, selected from ethylene glycol (1,2-ethane diol), propylene glycol (1,3-propane diol), 1,4-butane diol and 1,5-pentane diol.

13. The method as claimed in claim 1, wherein step b) is carried out a temperature from 100 °C to 165 °C, preferably from 110 °C to 160 °C, more preferably from 120 °C to 155 °C, and most preferably from 130 °C to 150 °C.

14. The method as claimed in claim 1, wherein a weight ratio of the alcoholic solvent to the waste polymer material ranges from 1:2 to 1:40.

15. The method as claimed in claim 1, wherein the polyester comprises polyethylene terephthalate.

16. The method as claimed in claim 1, wherein the ethylene vinyl alcohol copolymer comprises ethylene vinyl alcohol (EVOH) with an ethylene part between 20 mol % and 50 mol %.

17. The method as claimed in claim 1, wherein the waste polymer material comprises from 85-99 wt. % polyester and from 1-15 wt. % ethylene vinyl alcohol copolymer, and optionally a polyolefin and/or a chloride-containing polymer, the total adding up to 100 wt. %.

18. The method as claimed in claim 1, wherein step b) is carried out during from 0.5 h to 8 h, more preferably from 2 h to 6 h.

19. The method as claimed in claim 7, wherein the depolymerization is carried out at a temperature of at least 160 °C, preferably of at least 180 °C, more preferably of at least 190 °C, and even more preferably of at most 250 °C.

20. The method as claimed in claim 7, wherein the catalyst for depolymerizing the polyester comprises a functionalized magnetic particle that is functionalized with a catalytic moiety.

21. The method as claimed in claim 1, wherein the polyester obtained in step c) is washed in a suitable washing liquid, such as water or a polyalcohol, wherein the washing may include friction washing.
